(19) United States
(12) Patent Application Publication
(10) Pub. No.: US 2026/0054280 A1
(43) Pub. Date: Feb. 26, 2026

(54) SPRAY DEVICE

(71) Applicant: Panasonic Intellectual Property Management Co., Ltd., Osaka (JP)

(72) Inventor: NAOYA OKUBO, Osaka (JP)

(21) Appl. No.: 19/373,021

(22) Filed: Oct. 29, 2025

Related U.S. Application Data
(63) Continuation of application No. PCT/JP2024/013710, filed on Apr. 3, 2024.

(30) Foreign Application Priority Data
May 22, 2023 (JP) 2023-083751

(51) Int. Cl. B05B 7/04

(52) U.S. Cl. CPC B05B 7/0475

(57) ABSTRACT

By providing silencer (55) included in spray device (10) with a plurality of through-holes (80) for diverging gas-liquid mixture fluid sprayed through spray port (52), it is possible to reduce the turbulence of an airflow generated at the time of spraying, and to reduce the noise.

### TECHNICAL FIELD

The present invention relates to a spray device that atomizes liquid with gas.

### BACKGROUND ART

Nozzles for atomizing liquid are widely used in devices such as coolers for a space or substance, a humidifier, a chemical liquid sprinkler, a combustor, or a dust control device. Such atomizer nozzles are roughly classified into one-fluid nozzles that atomize liquid by ejecting liquid from finer pores, and two-fluid nozzles that atomize liquid using gas such as air, nitrogen, or vapor. In the comparison between the one-fluid nozzle and the two-fluid nozzle, the two-fluid nozzle is generally characterized by being superior in atomization performance to the one-fluid nozzle, because the two-fluid nozzle atomizes liquid using the energy of gas.

Examples of the two-fluid nozzle for atomizing liquid include a two-fluid nozzle disclosed in PTL 1.

As illustrated in FIG. 8, two-fluid nozzle spray device 310 described in PTL 1 includes at least spray device body 310a, inner lid 313, and outer lid 314. Inner lid 313, annular part 324, and outer lid 314 together form gas-liquid mixing unit 315. Spray device 310 also includes spray device lid fixture 317.

In spray device 310, a liquid flow is guided into gas-liquid mixing unit 315 from the side of inner end surface 313a of inner lid 313, and a gas flow is guided into gas-liquid mixing unit 315 in a direction intersecting with the flow of liquid, so as to collide with the liquid flow, and the resultant gas-liquid mixture fluid advances into spray unit 316 by circulating along the inner surface of annular part 324. In this manner, atomization of the liquid is promoted inside gas-liquid mixing unit 315. As a result, it is possible to provide a spray device capable of spraying a liquid having small particle diameters, which quickly vaporizes and does not cause any wet feel.

### CITATION LIST

### Patent Literature

PTL 1: Unexamined Japanese Patent Publication No. 2017-170422

### SUMMARY OF THE INVENTION

According to one aspect of the present disclosure, in a spray device that sprays, as mist, a gas-liquid mixture fluid obtained by mixing a liquid and a gas to atomize the liquid, the spray device includes a silencer disposed outside a spray port of the spray device through which the gas-liquid mixture fluid is sprayed, and the silencer includes a plurality of through-holes via which the gas-liquid mixture fluid sprayed out of the spray port is diverged.

### BRIEF DESCRIPTION OF THE DRAWINGS

FIG. 1 is a schematic end view of a cross section of a spray device according to an exemplary embodiment of the present disclosure.

FIG. 2A is an external perspective view of a gas-liquid spray unit including a silencer provided with a plurality of through-holes.

FIG. 2B is an arrow view of the silencer illustrated in FIG. 2A, in a view from the direction A in FIG. 2A.

FIG. 2C is an enlarged plan view of a part near the silencer illustrated in FIG. 2A, in a view looking down from above in FIG. 2A.

FIG. 3 is a correlation table between the number of rectangular through-holes, the long-side separation distance of the rectangular through-holes, and the spraying noise level.

FIG. 4 is a correlation table between the long-side separation distance of the rectangular through-hole and the noise level, given a through-hole separation distance of 0.8 mm.

FIG. 5 is a correlation table between the long-side separation distance of the rectangular through-hole and the noise level, given a through-hole separation distance of 0.6 mm.

FIG. 6 is a correlation table between the long-side separation distance of the rectangular through-hole and the noise level, given a through-hole separation distance of 0.4 mm.

FIG. 7 is a correlation table between the long-side separation distance of the rectangular through-hole and the noise level, given a through-hole separation distance of 0.3 mm.

FIG. 8 is a cross-sectional view illustrating a schematic configuration of a conventional spray device.

### DESCRIPTION OF EMBODIMENT

In the configuration of the conventional two-fluid nozzle described in PTL 1, there is a problem that large noise is generated by collision of the air and the water, the collision being necessary to generate atomized liquid having a particle size of smaller than or equal to 10 μm, or by a jet flow formed at the time when the fluid is sprayed. If the liquid particle size of smaller than or equal to 10 μm can be achieved while reducing the noise generated in spraying the fluid, such liquid can be used for humidifying a quiet environment such as indoors, heat alleviation, or spatial exhibition. When the two-fluid nozzle according to the conventional technique is used in such applications, it is necessary to take measures for reducing the noise, e.g., shielding the noise or moving the nozzle spray away from the user. Thus, the nozzle according to the conventional technique has a problem that the places of use or the applications are limited.

The present disclosure has been made to address the problem described above, and an object of the present disclosure is to provide a spray device that sprays liquid having a small particle diameter and generates less noise while the liquid is being sprayed.

An exemplary embodiment of the present disclosure will now be described with reference to the drawings.

An embodiment of the present disclosure relates to two-fluid nozzle spray device 10 that atomizes and sprays liquid using gas. Examples of the gas include air, nitrogen, oxygen, and an inert gas, and may be selected as appropriate, in a manner suitable for the usage. Examples of the liquid include water, ozone water, a chemical solution having sterilization and disinfection functions, paint, and fuel oil. The liquid can be selected as appropriate, in a manner suitable for the usage.

### Exemplary Embodiment

To describe the exemplary embodiment of the present disclosure, a configuration of spray device 10 will be described, to start with.

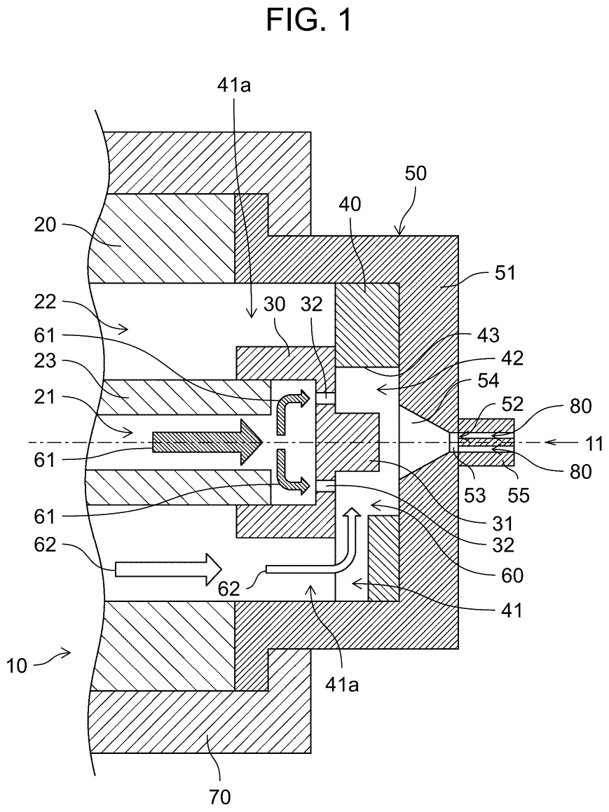

FIG. 1 is a sectional view of spray device 10 according to the exemplary embodiment of the present invention.

Spray device 10 includes at least spray device body 20, liquid inlet part 30, gas inlet part 40, and gas-liquid spray unit 50. Liquid inlet part 30, gas inlet part 40, and gas-liquid spray unit 50 together form gas-liquid mixing unit 60. Spray device 10 also includes gas-liquid spray unit fixture 70.

Spray device body 20 includes liquid channel 21 extending in the direction of central axis 11, along the central part of a cylindrical member, and cylindrical gas channel 22 disposed around liquid channel 21, with an interval therebetween, along the direction of central axis 11. Liquid channel 21 and gas channel 22 are partitioned by cylindrical tube 23 positioned in the central part, as a part of spray device body 20. Only the tip side of liquid channel 21 is illustrated, and a liquid supply port at the trailing end thereof, not illustrated, is connected to a pump or the like that is connected to a liquid tank or the like via a water supply pipe, or is directly connected to a water pipe, for example. For gas channel 22, too, only the tip side is illustrated, and a gas supply port at the trailing end thereof, not illustrated, is connected to a pneumatic source including an air compressor, via a gas supply pipe, for example.

The tip of cylindrical tube 23 protrudes slightly toward the tip side, from spray device body 20 other than cylindrical tube 23. To the tip of cylindrical tube 23, liquid inlet part 30 is fixed.

Liquid inlet part 30 is disposed at the tip of spray device body 20, and covers the opening at the tip of liquid channel 21. Liquid inlet part 30 has at least one liquid flow inlet port 32 penetrating in the direction of central axis 11, at a position separated from central axis 11 in the radial direction.

Liquid flow inlet port 32 is configured as a hole penetrating the end surface of liquid inlet part 30 along central axis 11, and liquid flow 61 flowing through liquid channel 21 is guided into gas-liquid mixing unit 60 through the hole of liquid flow inlet port 32. Liquid flow inlet port 32 is configured as, for example, a through-hole that communicates with internal of circular through-hole 42 provided to annular gas inlet part 40, and that is positioned near inner circumferential surface 43 of circular through-hole 42, on the upstream side of gas-liquid mixing unit 60. Gas-liquid mixing unit 60 is surrounded by liquid inlet part 30, gas inlet part 40, and gas-liquid spray unit 50. There is at least one through-hole forming liquid flow inlet port 32, and, as an example, two through-holes are disposed at intervals of 180 degrees about central axis 11. The through-hole forming liquid flow inlet port 32 connects the opening of liquid channel 21, which is covered by liquid inlet part 30, to gas-liquid mixing unit 60, so that the liquid flowing through liquid channel 21 flows into gas-liquid mixing unit 60.

Gas inlet part 40 is an annular member positioned between liquid inlet part 30 and gas-liquid spray unit 50, and is in surface contact with liquid inlet part 30 and gas-liquid spray unit 50. Gas inlet part 40 has gas flow inlet port 41 connecting gas channel 22 to gas-liquid mixing unit 60, as a cutout provided on a part of a side of the annular member in a direction intersecting with the axial direction (e.g., a direction orthogonal to the axis).

Gas flow inlet port 41 is provided to at least one point on annular gas inlet part 40, in a manner communicating with gas channel 22 and gas-liquid mixing unit 60 through gap 41a. Gas flow inlet port 41 guides gas flow 62 flowing through gas channel 22 into gas-liquid mixing unit 60 in a direction intersecting with liquid flow 61 flowing into gas-liquid mixing unit 60 through liquid flow inlet port 32, so as to atomize the liquid.

Furthermore, cylindrical projection 31 is provided at the center of the downstream end surface of liquid inlet part 30, in a manner projecting into gas-liquid mixing unit 60 along central axis 11. Projection 31 is disposed on the side closer to the central axis than liquid flow inlet port 32 is, but is not particularly necessary.

Gas-liquid spray unit 50 is a member having a substantially Ω cross-sectional shape, is disposed at the tip of spray device body 20, covers the liquid inlet part 30 and gas inlet part 40, and covers gas channel 22, to form gap 41a by delineating cylindrical outer shape. That is, gas-liquid spray unit 50 is nipped and fixed between the end surface of spray device body 20 and gas-liquid spray unit fixture 70. Gas-liquid spray unit 50 has a side covering liquid inlet part 30, while forming gap 41a delineating a cylindrical tube-like shape at a predetermined interval with respect to liquid inlet part 30. Gas-liquid spray unit 50 also has one end covering liquid inlet part 30 in such a manner that a gap is formed with respect to liquid inlet part 30, as gas-liquid mixing unit 60 delineating a predetermined interval and having a disk-like external shape. In this manner, gas inlet part 40 is nipped and fixed between gas-liquid spray unit 50 and liquid inlet part 30, along the central axis. Although gas inlet part 40 and liquid inlet part 30 are described as separate members, the present invention is not limited thereto, and gas inlet part 40 and liquid inlet part 30 may be integrated as one member.

Furthermore, provided at the center of tip portion 51 of gas-liquid spray unit 50 are tubular channel 53 through which gas-liquid mixture fluid exits, and spray port 52 that is in communication with tubular channel 53 and through which the gas-liquid mixture fluid is sprayed. On the inner surface of tip portion 51, a tapered flow straightening channel 54 having a truncated conical shape and communicating with tubular channel 53 is provided. Spray port 52 and tubular channel 53 are both disposed coaxially with liquid channel 21, along central axis 11. By contrast, liquid flow inlet port 32 is positioned offset from central axis 11.

Furthermore, as an example, silencer 55 having a rectangular parallelepiped shape is provided outside spray port 52 of gas-liquid spray unit 50. Silencer 55 has a plurality of, for example, two through-holes 80 connected to spray port 52, for diverging the gas-liquid mixture fluid sprayed through spray port 52. The gas-liquid mixture fluid is sprayed through each through-hole 80.

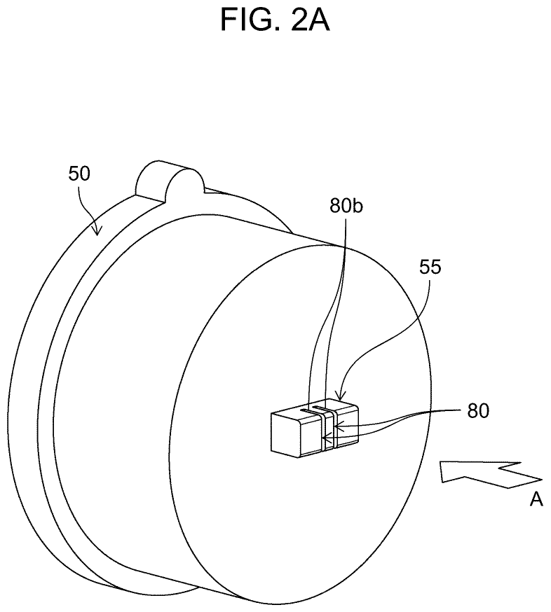

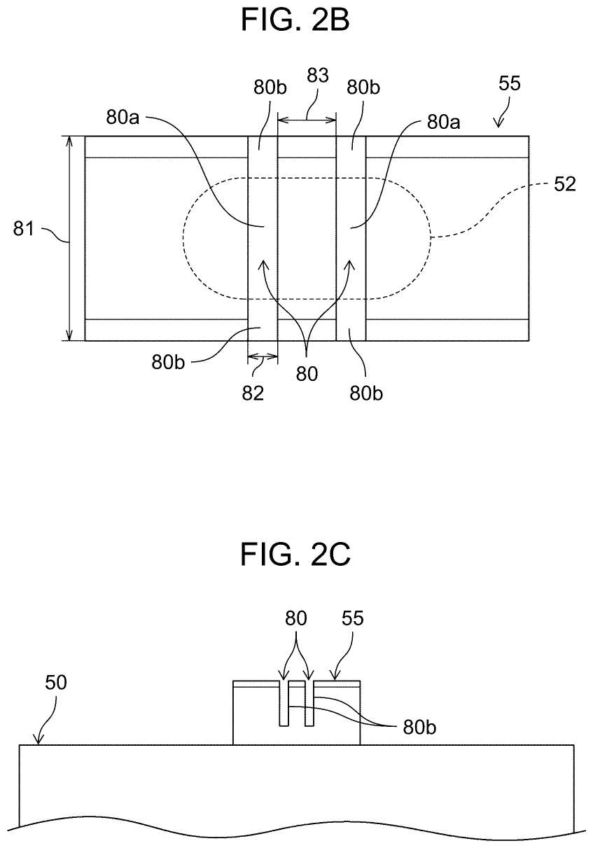

FIG. 2A is an external perspective view of gas-liquid spray unit 50 provided with silencer 55 having two through-holes 80 for diverging the gas-liquid mixture fluid sprayed from spray port 52. FIG. 2B is an arrow view of silencer 55 illustrated in FIG. 2A in a view from direction A in FIG. 2A. FIG. 2C is an enlarged plan view of a part near silencer 55 illustrated in FIG. 2A, in a view looking down from above in FIG. 2A. As illustrated in FIGS. 2A to 2C, as an example, through-holes 80 both have the same rectangular shape, in a view from the spraying direction, and extend straight in parallel with each other along central axis 11. On a plane orthogonal to central axis 11, for example, two through-holes 80 are disposed point-symmetrically about central axis 11.

Each through-hole 80 has through-hole main part 80a and opening grooves 80b.

Through-hole main part 80a is, as an example, a through-hole having a rectangular shape elongated in an up-down direction and penetrating silencer 55 in a direction along central axis 11 (that is, along the central axis of the spray device or the spraying direction), where silencer 55 has a rectangular parallelepiped shape elongated in a left-right direction. An opening on the upstream end of through-hole main part 80a is at a position corresponding to inside of spray port 52 having a substantially elliptical shape elongated in left-right direction, as illustrated in FIG. 2B as an example, and is in communication with spray port 52.

Opening grooves 80b are provided as cutouts each having a shape elongated in the same direction as the axial direction of through-hole main part 80a, at positions extending outwards with respect to spray port 52, on respective sides of the longitudinal direction of the rectangular through-hole of through-hole main part 80a, e.g., on the upper and the lower sides in FIG. 2A, respectively, on a plane orthogonal to central axis 11, and are in communication with through-hole main part 80a. Each through-hole main part 80a has opening grooves 80b on the upper and the lower sides thereof, respectively, in order to ensure a desired spray angle and to achieve mist with a desired particle diameter at the time of spraying, while ensuring the silencing function.

Gas-liquid spray unit 50 is nipped and fixed between gas-liquid spray unit fixture 70 and an end surface of spray device body 20. Gas-liquid spray unit 50 may also be fixed directly to the end surface of spray device body 20, without gas-liquid spray unit fixture 70.

In such a configuration, as illustrated in FIG. 1, the liquid supplied into spray device 10 passes through the liquid supply port, not illustrated, and flows through liquid channel 21 toward the tip side of the device, as liquid flow 61. The liquid flow 61 passes through liquid flow inlet port 32 on liquid inlet part 30, and is supplied into gas-liquid mixing unit 60. The gas supplied into spray device 10 passes through a gas supply port, not illustrated, flows through gas channel 22 toward the tip side of the device, as gas flow 62. Gas flow 62 passes through gas flow inlet port 41, and is supplied into gas-liquid mixing unit 60.

Gas-liquid mixing unit 60 receives gas flow 62 and liquid flow 61, mixes gas flow 62 and liquid flow 61 in gas-liquid mixing unit 60, and atomizes the liquid. Through-holes 80 of silencer 55 receive atomized liquid through spray port 52 on gas-liquid spray unit 50, and spray the atomized liquid to the outside of spray device 10.

According to the present embodiment, the gas-liquid mixture fluid sprayed out of each of two rectangular through-holes 80 of silencer 55 interfere with that sprayed out of the other through-hole 80, and suppresses the formation of a vortex resultant of friction with static fluid. As a result, it is possible to provide a spray device that sprays a liquid having a small particle diameter, with lower spraying noise, and that generates less spraying noise. Therefore, the spray device can be used for a wider range of applications.

For the purpose of comparison, to begin with, the noise generated by spray device 10 according to a comparative example, which is spray device 100 according to the exemplary embodiment with silencer 55 removed, is measured, and then the noise of spray device 10 with silencer 55 attached thereto is measured.

A specific example of the common dimensions shared between spray device 10 according to this embodiment and spray device 100 according to the comparative example includes the cylindrical tubular shape of gas-liquid mixing unit 60 the inner diameter of which is 4.2 mm and the height of which is 1.3 mm. Spray port 52 of gas-liquid spray unit 50 is an elongated round hole having a diameter of 0.6 mm and a straight part of 0.8 mm. Flow straightening channel 54 has a diameter of 3.0 mm on the side with a larger surface area, and a diameter of 0.6 mm on the side with a smaller surface area, and is an elongated round hole with a straight part of 0.8 mm, and the length of which is 1.9 mm. Liquid flow inlet port 32 has a diameter of 0.4 mm. Gas flow inlet ports 41 each have a rectangular cross-sectional shape with a width of 1.3 mm and a height of 0.7 mm, and are provided to two respective points that are symmetrical with respect to central axis 11. In spray device 100 according to the comparative example, the only one through-hole provided to a rectangular parallelepiped member, which is provided instead of the silencer, has a rectangular shape the long side of which is 1.4 mm and the short side of which is 0.3 mm.

To these spray devices 10 and 100, water, as an example of the liquid, was supplied at 20 mL/min, and compressed air, as an example of the gas, was supplied so as to achieve atomized water having a Sauter mean particle diameter of 6.0 μm. The Sauter mean particle diameter of atomized water was evaluated using a laser diffraction method, and a measurement distance for the laser diffraction method was set to a position of 100 mm from the tip of spray device 10, 100. The noise was then measured under these conditions, using a noise meter at a position 1000 mm from the tip of spray device 100 according to the comparative example, and obtained a measurement of 62.5 dB (A-weighted sound level).

The Sauter mean particle diameter is a diameter of a particle the ratio of its volume with respect to its surface area is the same as the ratio of the total volume of all of the particles to the total surface area of all of the particles. When there are ni particles each having diameter di, the Sauter mean particle diameter (often denoted as D32) is given by Expression below.

$$D 32 = \sum {nidi}^{3} / \sum {nidi}^{2}$$

In spray device 100 according to the comparative example having the configuration described above, when the atomized gas-liquid mixture fluid was sprayed through spray port 52, a turbulence flow is generated between the gas-liquid mixture fluid and the outside air, as a result of friction between the high-speed sprayed gas-liquid mixture fluid and the outside air. This is considered to be one of the causes of noise generated during spraying.

As a specific example, spray device 10 according to the exemplary embodiment includes silencer 55 having two through-holes 80 for diverging the gas-liquid mixture fluid sprayed through spray port 52. Each of the two through-holes 80 has a rectangular shape in a view from spraying direction, long-side length 81 of 1.4 mm, long-side separation distance 82 of 0.15 mm, and the minimum distance between the adjacent rectangular through-holes 80 is 0.4 mm. Hereinafter, the minimum distance between adjacent rectangular through-holes 80 will be referred to as a through-hole separation distance 83. Noise was then measured for spray device 10 incorporated with silencer 55 having the configuration described above, under the same conditions as those described above. As a result, the noise level was 56.8 dB (A-weighted sound level), and a noise reduction effect of −5.7 dB (A-weighted sound level) was achieved, in the comparison with spray device 100 according to the comparative example not provided with silencer 55.

With the configuration described above, the speed of the jet flow of the gas-liquid mixture fluid sprayed out of spray port 52 can be reduced, without reducing the velocity gradient of the jet flow. The noise generated by a jet flow changes proportionally to the jet flow speed, and atomization is promoted more when the velocity gradient is greater. Therefore, the noise at the time of spraying can be reduced while maintaining the spray characteristics such as the particle diameter.

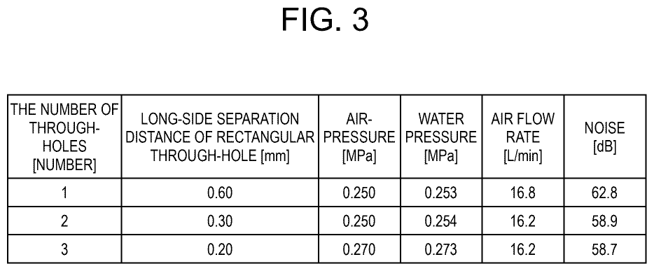

Next, FIG. 3 indicates a correlation between the number of rectangular through-holes 80, long-side separation distance 82 of rectangular through-hole 80, and the level of spraying noise. The example with one rectangular through-hole corresponds to spray device 100 according to the comparative example. The number of rectangular through-holes 80 and long-side separation distance 82 were changed without changing the total area of the openings of the plurality of through-holes 80 of spray device 10 according to the exemplary embodiment, the openings being open to the outside. As the number of rectangular through-holes 80 was increased, the noise decreased. The highest noise reduction effect was achieved when the number of rectangular through-holes 80 was three, but not much difference was observed between the cases where the number of rectangular through-holes 80 was two and where the number of rectangular through-holes 80 was three. By contrast, when the number of rectangular through-holes 80 was three, the pressure of the compressed air required to spray the liquid increased, because of the increase in the pressure loss accrued in passing the liquid through rectangular through-holes 80.

On the basis of the above, it is preferable to provide two rectangular through-holes 80, from the viewpoint of the spraying noise and energy consumption.

Next, a correlation between long-side separation distance 82 and through-hole separation distance 83 of rectangular through-holes 80, and the level of spraying noise was examined.

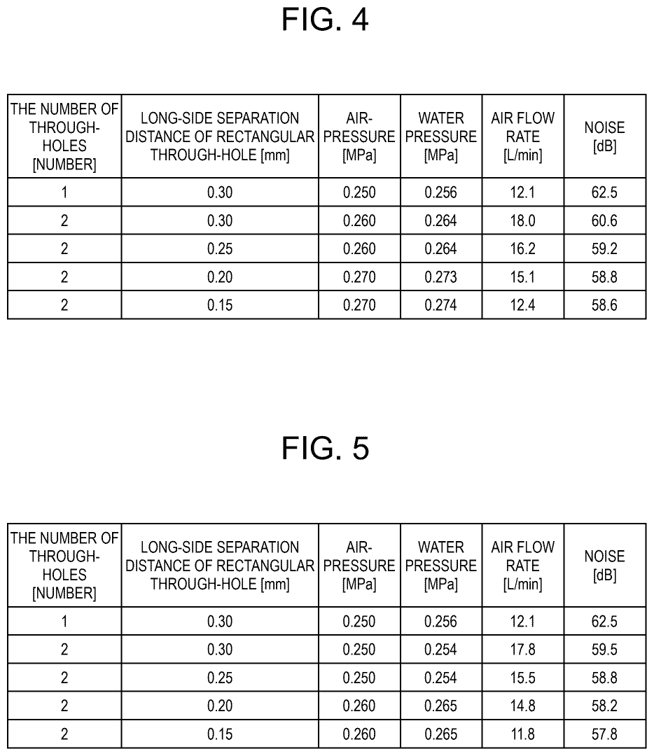

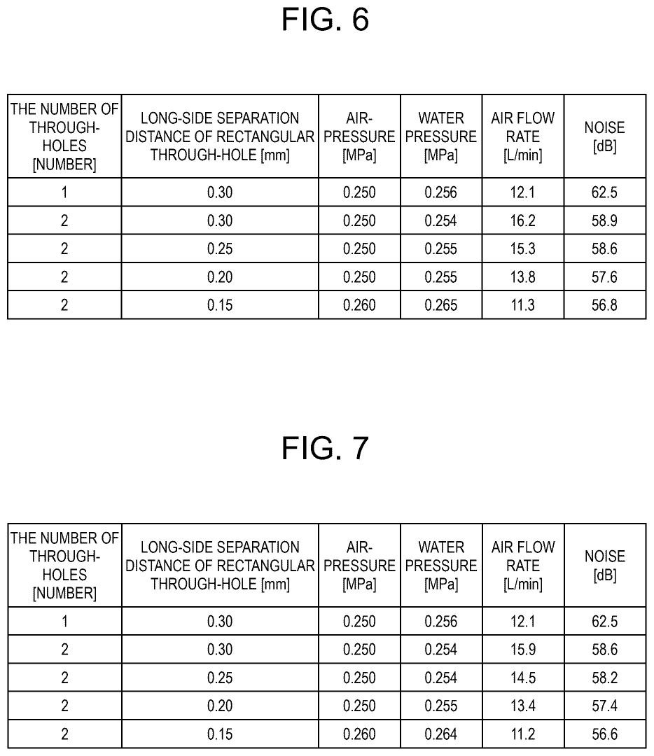

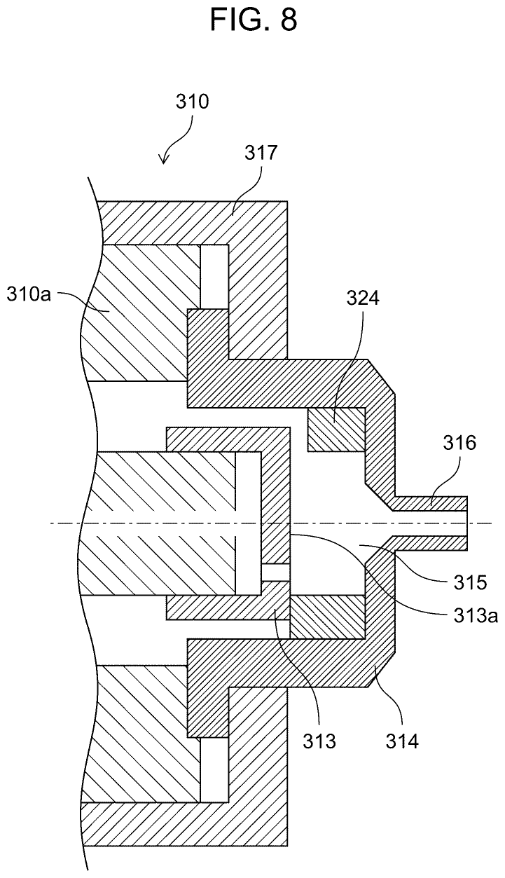

Specifically, long-side separation distance 82 of rectangular through-hole 80 was changed at increments of 0.05 mm, within a range from 0.30 mm to 0.15 mm, and through-hole separation distance 83 was changed at four increments of 0.30 mm (see FIG. 7), 0.40 mm (see FIG. 6), 0.60 mm (see FIG. 5), and 0.80 mm (see FIG. 4).

Noise was then measured for spray device 10 incorporated with silencer 55 having the configuration described above, under the same conditions as those described above. FIGS. 4 to 7 indicate correlations between each through-hole separation distance 83 and the level of spraying noise, with varying long-side separation distances 82 of rectangular through-hole 80. With all of these through-hole separation distances 83, the spraying noise decreased further when long-side separation distance 82 of rectangular through-holes 80 was shorter.

With respect to through-hole separation distance 83, comparisons were made between a case with there is one through-hole 80 the long-side separation distance 82 of which 0.30 mm, and a case in which there are two through-holes 80 the long-side separation distance 82 is 0.15 mm, these cases being cases in which the total areas of the openings of the plurality of rectangular through-holes 80 are the same, the openings being open to the outside. In the descending order of through-hole separation distances 83, the levels of spraying noise were 58.6 dB (0.80 mm in FIG. 4), 57.8 dB (0.60 mm in FIG. 5), 56.8 dB (0.40 mm in FIG. 6), and 56.6 dB (0.30 mm in FIG. 7), respectively, and the effect of reducing spraying noise became better. This can be considered as follows. In general, noise associated with a jet flow is generated by a vortex formed as a result of turbulent mixing, which is resultant of fluid friction caused by the velocity difference between the jet flow and static fluid therearound. Therefore, it can be considered that, in these noise measurements, the spraying noise is reduced because the streams of gas-liquid mixture fluid sprayed out of the respective rectangular through-holes 80 interfered with each other and suppressed formation of a vortex, which is resultant of friction with the static fluid. Furthermore, as through-hole separation distance 83 was increased, the air flow rate required for spraying increased, from 11.2 L/min (with 0.30 mm in FIG. 7), 11.3 L/min (with 0.40 mm in FIG. 6), 11.8 L/min (with 0.60 mm in FIG. 5), to 12.4 L/min (with 0.80 mm in FIG. 4). The air flow rate of 12.4 L/min and the air pressure of 0.270 MPa required for spraying with through-hole separation distance 83 of larger than or equal to 0.80 mm were higher than the air flow rate of 12.1 L/min and the air pressure of 0.250 MPa required for spraying with silencer 55 not provided with any rectangular through-hole 80 (that is, the example with one through-hole in FIG. 4), and the energy consumption also increased. By contrast, the air flow rates 11.8 L/min, 11.3 L/min, and 11.2 L/min (the air pressure in each case is 0.260 MPa) required for spraying in the cases illustrated in FIGS. 5 to 7, in which through-hole separation distance 83 was set smaller than or equal to 0.60 mm, were lower than the air flow rates 12.1 L/min, 12.1 L/min, and 12.1 L/min (the air pressure in each case is 0.250 MPa) required for spraying with silencer 55 not provided with any rectangular through-hole 80 (that is, the example with one through-hole in FIGS. 5 to 7), and the energy consumption also decreased.

On the basis of the above, it is preferable to provide two rectangular through-holes 80 at through-hole separation distance 83 of smaller than or equal to 0.60, from the viewpoint of the level of spraying noise and energy consumption. From the viewpoint of manufacturing, two rectangular through-holes 80 are provided at through-hole separation distance 83 of larger than or equal to 0.1 mm or more.

Furthermore, it is possible to achieve the noise-suppressing effect even when silencer 55 is attached to the tip of a mist nozzle other than spray device 10 in FIG. 1.

By combining any of the various exemplary embodiments and modifications described above as appropriate, the effect exerted by each of the exemplary embodiments or modifications can be achieved. Combination of exemplary embodiments, combination of examples, or combination of exemplary embodiments and examples are possible, and combination of features in different exemplary embodiments or examples are also possible.

As described above, with the spray device according to one aspect of the present disclosure, the streams of gas-liquid mixture fluid sprayed out of the plurality of respective through-holes of the silencer interfere with each other, and formation of a vortex resultant of the friction with the static fluid is suppressed. Therefore, it is possible to provide a spray device that sprays a liquid having a small particle diameter, with lower spraying noise, and that generates less spraying noise. Therefore, the spray device can be used for a wider range of applications.

### INDUSTRIAL APPLICABILITY

The spray device according to the above aspect of the present disclosure is a spray device capable of spraying a liquid finely and with low noise, and the spray device can be widely used for cooling a space or a substance, humidification, chemical spraying, combustion, spatial presentation, and the like.

### REFERENCE MARKS IN THE DRAWINGS

10: spray device
11: central axis
20: spray device body
21: liquid channel
22: gas channel
23: cylindrical tube
30: liquid inlet part
31: projection
32: liquid flow inlet port
40: gas inlet part
41: gas flow inlet port
41a: gap
42: circular through-holes provided to gas inlet part
43: inner circumferential surface of circular through-hole of gas inlet part
50: gas-liquid spray unit
51: tip portion
52: spray port
53: tubular channel
54: flow straightening channel
55: silencer
60: gas-liquid mixing unit
61: liquid flow
62: gas flow
70: gas-liquid spray unit fixture
80: through-hole
81: long-side length
82: long-side separation distance
83: through-hole separation distance

1. A spray device that sprays, as mist, a gas-liquid mixture fluid obtained by mixing a liquid and a gas to atomize the liquid, the spray device comprising
a silencer disposed outside a spray port of the spray device through which the gas-liquid mixture fluid is sprayed, wherein
the silencer includes a plurality of through-holes via which the gas-liquid mixture fluid sprayed out of the spray port is diverged.

2. The spray device according to claim 1, wherein each of the plurality of through-holes has an identical rectangular shape in a view from a spraying direction, and the plurality of through-holes are parallel to each other.

3. The spray device according to claim 2, wherein each of the plurality of through-holes includes:
a rectangular through-hole main part penetrating in a direction along a central axis of the spray device and communicating with the spray port; and
opening grooves provided on opposite sides of the rectangular through-hole main part, communicating with the rectangular through-hole main part, and provided to positions projecting outwards from the spray port, on a plane orthogonal to the central axis.

4. The spray device according to claim 2, wherein a minimum distance between adjacent through-holes among the plurality of through-holes is from 0.1 mm to 0.6 mm inclusive.

5. The spray device according to claim 1, further comprising:
a spray device body having a liquid channel for the liquid and a gas channel for the gas;
a liquid inlet part disposed at a tip of a cylindrical tube, the tip being on a central axis of the spray device body, and covering an opening of the liquid channel;
a gas-liquid spray unit disposed at a tip of the spray device body, covering the liquid inlet part, and covering an opening of the gas channel;
an annular gas inlet part disposed between the liquid inlet part and the gas-liquid spray unit, and being in surface contact with the liquid inlet part and the gas-liquid spray unit;
a liquid flow inlet port connecting the opening of the liquid channel covered by the liquid inlet part to a gas-liquid mixing unit surrounded by the liquid inlet part, the gas inlet part, and the gas-liquid spray unit; and
a gas flow inlet port provided to at least one point on the annular gas inlet part so as to connect the gas channel to the gas-liquid mixing unit, and guiding a gas flow flowing through the gas channel into the gas-liquid mixing unit in a direction intersecting with a liquid flow flowing through the liquid flow inlet port into the gas-liquid mixing unit, so as to atomize the liquid in the gas-liquid mixing unit, wherein
the spray port is provided to the gas-liquid spray unit, communicates with the gas-liquid mixing unit, and sprays the liquid having been atomized in the gas-liquid mixing unit.
